(19) United States
(12) Patent Application Publication
(10) Pub. No.: US 2022/0183338 A1
(43) Pub. Date: Jun. 16, 2022

(54) PROTEIN-CONTAINING ORAL COMPOSITION AND METHOD FOR IMPROVING FLAVOR OF PROTEIN-CONTAINING ORAL COMPOSITION

(71) Applicant: SUNTORY HOLDINGS LIMITED, Osaka-shi, Osaka (JP)

(72) Inventors: Kyoko Hasebe, Soraku-gun (JP); Noriko Matsui, Soraku-gun (JP)

(73) Assignee: SUNTORY HOLDINGS LIMITED, Osaka-shi, Osaka (JP)

(21) Appl. No.: 17/432,213

(22) PCT Filed: Feb. 18, 2020
(86) PCT No.: PCT/JP2020/006293

§ 371 Date: Aug. 19, 2021

(30) Foreign Application Priority Data
Feb. 20, 2019 (JP) 2019-028604

(51) Int. Cl. A23L 27/00; A23L 33/19; A23L 33/185; A23L 33/105; A23L 33/175

(52) U.S. Cl. CPC A23L 27/84; A23L 33/19; A23V 2002/00; A23L 33/105; A23L 33/175; A23L 33/185

(57) ABSTRACT

The present, invention aims to provide a protein-containing oral composition in which the unpleasant flavor of proteins is reduced, and a method of improving the flavor of a protein-containing oral composition which can reduce the unpleasant flavor of proteins. The present invention relates to a protein-containing oral composition containing a protein and hydroxypropyl cellulose at a ratio by weight of the hydroxypropyl cellulose to the protein (hydroxypropyl cellulose/protein) of 0.020 to 0.50, and the like.

### TECHNICAL FIELD

The present invention relates to a protein-containing oral composition. The present invention also relates to a method of improving the flavor of a protein-containing oral composition, and the like.

### BACKGROUND ART

Proteins are one of the essential nutrients to maintain good health. Proteins such as milk protein and soy protein are used in food, beverages, and the like for the purpose of protein supplementation, for example. Proteins, however, have unique taste and smell, and thus spoil the flavor of food or a beverage when used in the food or beverage.

A sweetener or flavoring is usually added as a masking agent to reduce the unpleasant flavor of proteins. Patent Literature 1 discloses a method of improving the flavor of food or a beverage, including adding ethyl decanoate to food or a beverage containing collagen, soy protein, milk protein, or the like.

### CITATION LIST

### Patent Literature

Patent Literature 1: JP 2006-197857 A

### SUMMARY OF INVENTION

Technical Problem

The present invention aims to provide a protein-containing oral composition in which the unpleasant flavor of proteins is reduced. The present invention also aims to provide a method of improving the flavor of a protein-containing oral composition which can reduce the unpleasant flavor of proteins.

Solution to Problem

The present inventors made intensive studies to respond to the issues above and found that use of hydrozypropyl cellulose (HPC) can reduce (soften) the unpleasant flavor of a protein, particularly the unpleasant aftertaste thereof, to improve the flavor of an oral composition containing the protein. Masking the unpleasant flavor of the protein with a sweetener or the like requires addition of a certain amount of sweetener or the like, which may result in very strong sweetness or the like that spoils the flavor of the composition. Meanwhile, masking with a flavoring such as ethyl decanoate described in Patent Literature 1 may add the flavor of the flavoring to the composition. Use of hydroxyprcpyl cellulose can reduce the unpleasant flavor of the protein without adding such a flavor of a sweetener or flavoring.

The present invention encompasses, but is not limited to, the following protein-containing oral compositions, methods of improving the flavor of a protein-containing oral composition, and the like.

(1) A protein-containing oral composition containing a protein and hydrozypropyl cellulose at a ratio by weight of the hydroxypropyl cellulose to the protein (hydroxypropyl cellulose/protein) of 0.020 to 0.50.

(2) The protein-containing oral composition according to (1) above, wherein the ratio by weight of the hydroxypropyl cellulose to the protein (hydroxypropyl cellulose/protein) is 0.025 to 0.20.

(3) The protein-containing oral composition according to (1) or (2) above, wherein the protein is at least one of milk protein or soy protein.

(4) The protein-containing oral composition according to any one of <1) to (3) above, further containing at least one of quercetin or a quercetin glycoside.

(5) The protein-containing oral composition according to any one of (1) to (4), further containing at least one amino acid selected from the group consisting of leucine, isoleucine, and valine.

(6) A method of improving a flavor of a protein-containing oral composition, including adding hydroxypropyl cellulose to a protein-containing oral composition.

(7) The method of improving a flavor according to (6) above, wherein the hydroxypropyl cellulose is added such that a ratio by weight of the hydroxypropyl cellulose to the protein (hydroxypropyl cellulose/protein) is 0.020 to 0.50.

(8) The method of improving a flavor according to (6) or (7) above, wherein the hydroxypropyl cellulose is added such that a ratio by weight of the hydroxypropyl cellulose to the protein (hydroxypropyl cellulose/protein) is 0.025 to 0.20.

(9) The method of improving a flavor according to any one of (6) to (8) above, wherein the protein is at least one of milk protein or soy protein.

(10) The method of improving a flavor according to any one of (6) to (9), wherein the protein-containing oral composition further contains at least one of quercetin or a quercetin glycoside.

(11) The method of improving a flavor according to any one of (6) to (10), wherein the protein-containing oral composition further contains at least one amino acid selected from the group consisting of leucine, isoleucine, and valine.

(12) Use of hydroxypropyl cellulose for improving a flavor of a protein-containing oral composition.

Advantageous Effects of Invention

The present invention can provide a protein-containing oral composition in which the unpleasant flavor of proteins is reduced. The present invention also can provide a method of improving the flavor of a protein-containing oral composition which can reduce the unpleasant flavor of proteins.

### DESCRIPTION OF EMBODIMENTS

The protein-containing oral composition (hereinafter, also referred to as the “oral composition”) of the present invention contains a protein and hydroxypropyl cellulose at a ratio by weight of the hydroxypropyl cellulose to the protein (hydroxypropyl cellulose/protein) of 0.020 to 0.50. Containing the hydroxypropyl cellulose in the proportion above, the oral composition of the present invention has an improved flavor with the unpleasant flavor of proteins reduced. The protein-containing oral composition having such a reduced flavor of proteins is more palatable. In addition, use of the hydroxypropyl cellulose, which provides no sweet taste or the like, has an advantage of providing a higher degree of freedom in flavor to the protein-containing oral composition.

The protein to be used in the present invention may be milk protein, soy protein, egg protein, wheat protein, or the like. One type of protein may be used, or two or more types of proteins may be used. In particular, the protein is preferably at least one of milk protein or soy protein, more preferably milk protein.

The milk protein may be whey protein, casein protein, or the like, and is preferably whey protein. The protein in the present invention is more preferably whey protein. In one embodiment, the milk protein is preferably cow's milk protein.

Whey protein refers to a protein contained in milk serum (whey) isolated by removing casein and milk fat from milk such as cow's milk. A whey protein-containing oral composition can be prepared using a whey protein-containing raw material. Examples of the whey protein-containing raw material include whey protein concentrates (WPC) (protein content is about 80 wt %) and whey protein isolates (WPI) (protein content is 90 wt % or more).

Soy protein is a protein contained in soybean. Examples of soy protein-containing raw materials include soy protein isolates and soy protein concentrates.

The protein can be a commercially available product. Examples of commercially available whey protein-containing raw materials include Lactocrystal plus (trade name, Nippon Shinyaku Co., Ltd.) and Wheyco W80 (trade name, Nippon Shinyaku Co., Ltd.). Examples of commercially available soy protein-containing raw materials include Proleena 800R (trade name, Fuji Oil Co., Ltd.).

In order to reduce the flavor of proteins, the ratio by weight of the hydroxypropyl cellulose to the protein (hydroxypropyl cellulose/protein) in the oral composition is preferably 0.025 or more, more preferably 0.027 or more, while preferably 0.20 or less, more preferably 0.16 or less still more preferably 0.10 or less, particularly preferably 0.065 or less. In one embodiment, the ratio by weight of the hydroxypropyl cellulose to the protein (hydroxypropyl cellulose/protein) in the oral composition is preferably 0.025 to 0.20, more preferably 0.027 to 0.16, still more preferably 0.027 to 0.10, particularly preferably 0.027 to 0.065.

The oral composition of the present invention contains the protein in an amount of preferably 10 wt % or more, preferably 36 wt % or more, more preferably 40 wt % or more, still more preferably 50 wt % or more, particularly preferably 60 wt % or more, while preferably 80 wt % or less, more preferably 75 wt % or less. In one embodiment, the oral composition contains the protein in an amount of preferably 10 to 80 wt %, preferably 36 to 80 wt %, more preferably 36 to 75 wt %, still more preferably 40 to 75 wt % even more preferably 50 to 75 wt %, particularly preferably 60 to 75 wt %. When the oral composition contains two or more types of proteins, the amount of the protein is the sum of the amounts of these proteins. In one embodiment, the oral composition contains the protein in its solids content in an amount of preferably 10 to 80 wt %, preferably 36 to 80 wt %, more preferably 36 to 75 wt %, still more preferably 40 to 75 wt %, even more preferably 50 to 75 wt %, particularly preferably 60 to 75 wt %. Containing the hydroxypropyl cellulose in the above proportion, the oral composition containing the protein in an amount in the above ranges especially can reduce the flavor of the protein. The amount of the protein in the oral composition can be measured for example, by the combustion method.

Hydroxypropyl cellulose is a cellulose derivative obtainable by reacting hydroxy groups of cellulose with propylene oxide. Hydroxypropyl cellulose has been widely used as a food additive. Hydroxypropyl cellulose used in the present invention is soluble in water. Hydroxypropyl cellulose preferably has a weight average molecular weight of 20000 to 150000, more preferably 30000 to 140000, still mere preferably 35000 to 100000. Hydroxypropyl cellulose having a lower molecular weight has a larger number of terminal hydroxy groups, thereby exhibiting higher hydrophilicity. Hydroxypropyl cellulose having a weight average molecular weight in the above ranges provides good dispersibility in water, for example, to the oral composition. The molecular weight of the hydroxypropyl cellulose is easily measurable by gel permeation chromatography (GPC).

Hydroxypropyl cellulose may be a commercially available one, and is preferably one commercially available as a food additive. Examples of hydroxypropyl cellulose products commercially available as food additives include CELNY SSL (trade name, molecular weight: 40000), CELNY SL (trade name, molecular weight: 100000), and CELNY L (trade name, molecular weight: 140000) which are available from Nippon Soda Co., Ltd. In the present invention, CELNY SSL is preferred.

The oral composition of the present invention contains the hydroxypropyl cellulose in an amount of preferably 0.1 wt % or more, more preferably 1 wt % or more, still more preferably 2 wt % or more, while preferably 14 wt % or less, more preferably 13 wt % or less, still more preferably 10 wt % or less, particularly preferably 5 wt % or less. In one embodiment, the oral composition contains the hydroxypropyl cellulose in an amount of preferably 0.1 to 14 wt %, more preferably 1 to 13 wt %, still more preferably 1 to 10 wt %, even more preferably 1 to 5 wt %, particularly preferably 2 to 5 wt %. In one embodiment, the oral composition contains the hydroxypropyl cellulose in its solids content of preferably 0.1 to 14 wt %, more preferably 1 to 13 wt %, still more preferably 1 to 10 wt %, even more preferably 1 to 5 v/t %, particularly preferably 2 to 5 wt %.

The protein-containing oral composition of the present invention may contain a component(s) other than the protein and the hydroxypropyl cellulose.

In one embodiment, the protein-containing oral composition of the present invention may contain at least one of quercetin or a quercetin glycoside. Quercetin refers to a flavonol compound which is one of polyphenols. Examples of the quercetin glycoside include rutin, enzymatically modified rutin, quercitrin, and isoquercitrin. In the present invention, the quercetin glycoside is preferably enzymatically modified rutin. Enzymatically modified rutin is also sometimes referred to as enzymatically modified isoquercitrin or transglycosylated rutin. One compound selected from quercetin and quercetin glycosides may be used, or two or more compounds selected from quercetin and quercetin glycosides may be used. Quercetin and its glycosides are commercially available and may be commercially available products. Examples of commercially available products of enzymatically modified rutin, which is one example of the quercetin glycoside, include San emiq P30 (trade name, San-Ei Gen F.F.I., Inc.).

Quercetin and quercetin glycosides have a unique puckery taste. Hydroxypropyl cellulose is effective also in reducing the puckery taste of quercetin and quercetin glycosides. The protein-containing oral composition of the present invention, when containing at least one of quercetin or a quercetin glycoside, have a reduced unpleasant flavor of proteins and a reduced puckery taste, such as a reduced puckery aftertaste, of the at least one of quercetin or a quercetin glycoside, thereby having an improved flavor.

When the oral composition of the present invention contains at least one of quercetin or a quercetin glycoside the ratio by weight ((quercetin and quercetin glycoside)/protein) of the sum of the amounts of quercetin and the quercetin glycoside to the protein in the composition may be 0.001 or more or may be 0.005 or more, and is preferably 0.10, more preferably 0.05 or less, still more preferably 0.02 or less. In one embodiment, the ratio by weight ((quercetin and quercetin glycoside)/protein) of the sum of the amounts of quercetin and the quercetin glycoside to the protein in the oral composition is preferably 0.001 to 0.10, more preferably 0.005 to 0.05, still more preferably 0.005 to 0.02. The ratio by weight of the sum of the amounts of quercetin and the quercetin glycoside to the protein in the composition in the above ranges can further reduce the puckery taste of the at least one of quercetin or a quercetin glycoside in addition to the unpleasant flavor of the protein.

When the oral composition of the present invention contains at least one of quercetin or a quercetin glycoside the sum of the amounts of quercetin and quercetin glycoside in the oral composition is preferably 0.1 to 2 wt %, more preferably 0.1 to 1 wt %, in order to further reduce the puckery taste. In one embodiment, the oral composition of the present invention preferably contains a quercetin glycoside, preferably a quercetin glycoside in an amount in the above ranges. In one embodiment, the oral composition contains quercetin and the quercetin glycoside in its solids content in a total amount of preferably 0.1 to 2 wt % more preferably 0.1 to 1 wt %.

In one embodiment, the protein-containing oral composition of the present invention may contain a free amino acid such as at least one amino acid selected from the group consisting of leucine, isoleucine, and valine. In particular, the composition preferably contains leucine. Leucine, isoleucine, and valine may each be in the L form or D form, but is preferably in the L form. Leucine, isoleucine, and valine, which are branched chain amino acids, have a unique bitter taste. Hydroxyprcpyl cellulose is effective also in reducing the bitter taste of branched chain amino acids such as leucine. The protein-containing oral composition of the present invention, when containing at least one amino acid selected from the group consisting of leucine, isoleucine, and valine, can have a reduced bitter taste, such as a reduced bitter aftertaste, of the amino acids such as leucine, in addition to the reduced unpleasant flavor of the protein, thereby having an improved flavor.

When the oral composition of the present invention contains at least one amino acid selected from the group consisting of leucine, isoleucine, and valine, the ratio by weight of the sum of the amounts of leucine, isoleucine, and valine to the protein ((leucine, isoleucine, and valine)/protein) in the composition may be 0.01 or more, and is preferably 0.15 or less, more preferably 0.05 or less, still more preferably 0.03 or less. In one embodiment, the ratio by weight of the sum of the amounts of leucine, isoleucine, and valine to the protein ((leucine isoleucine, and valine)/protein) is preferably 0.01 to 0.15 more preferably 0.01 to 0.05, still more preferably 0.01 to 0.03. Also, in one embodiment of the oral composition, the ratio by weight of leucine to the protein (leucine/protein) is preferably 0.01 to 0.15, more preferably 0.01 to 0.05, still more preferably 0.01 to 0.03. When the ratio by weight of the amount of the amino acids including leucine to the amount of the protein is in the above ranges, the unpleasant flavor of the protein can be reduced, and the bitter taste of the amino acids can be further reduced.

When the oral composition of the present invention contains the amino acid, the sum of the amounts of leucine, isoleucine, and valine in the oral composition is preferably 5 wt % or less, more preferably 0.5 to 3 wt % in order to further reduce the bitter taste. In one embodiment of the oral composition, the amount of leucine is preferably 5 wt % or less, more preferably 0.5 to 3 wt %, still more preferably 0.5 to 1 wt %. In one embodiment, the oral composition contains leucine, isoleucine, and valine in its solids content in a total amount of preferably 5 wt % or less, more preferably 0.5 to 3 wt %. In one embodiment, the oral composition contains leucine in its solids content of preferably 5 wt % or less, more preferably 0.5 to 3 wt %, still more preferably 0.5 to 1 wt. %.

In one embodiment of the present invention, the oral composition may contain at least one selected from the group consisting of quercetin, quercetin glycosides, leucine, isoleucine, and valine, and may contain at least one selected from the group consisting of quercetin, quercetin glycosides, and leucine.

The oral composition of the present invention may contain, for example, minerals (e.g., calcium) and vitamins (e.g., vitamin D, vitamin C) in addition to the above components.

The oral composition of the present invention may contain an additive(s) usable in food, beverages, or pharmaceutical products in addition to the above components Examples of the additive(s) include excipients (e.g., dextrin, starch), thickeners (e.g., xanthan gum, guar gum), emulsifiers (e.g., glycerin fatty acid ester), sweeteners (e.g., sucralose, acesulfame potassium, aspartame, stevia), and flavorings.

The oral composition of the present invention can be used in food and beverages, for example. In one embodiment the composition of the present invention may be consumed directly as food or a beverage. Also, the oral composition of the present invention may be mixed into food or a beverage. The oral composition of the present invention may be used in any food and beverages. The oral composition of the present invention is preferably in a solid form (which encompasses powder and granules). The oral composition of the present invention may be in the form of, for example, powder, granules, tablets, or gummy food.

In one embodiment of the present invention, the protein-containing oral composition is suitable as a solid drink mix (solid drink mix composition). The solid drink mix is a solid composition which is mixed into a solvent for drinking such as water, cow's milk, or the like to prepare a beverage. The solid drink mix may be in the desired form such as powder, granules, tablets, or the like. In one embodiment, the oral composition of the present invention is preferably a solid drink mix such as a powder drink mix or a granular drink mix. Containing the hydroxypropyl cellulose in the above proportion, the protein-containing solid drink mix can reduce the unpleasant flavor of the protein when mixed into water or the like to prepare a beverage. In one embodiment, the solid drink mix may be mixed into a solvent for drinking such as water to a protein concentration of 6 wt % or less (for example, 0.3 to 6 wt %) to provide a beverage.

The oral composition of the present invention can be produced by any method such as adding hydroxypropyl cellulose to a protein-containing composition. The present invention encompasses a method of producing a protein-containing oral composition, including adding hydroxypropyl cellulose to a protein-containing composition such that a ratio by weight of the hydroxypropyl cellulose to the protein (hydroxypropyl cellulose/protein) is 0.020 to 0.50. When components such as the at least one of quercetin or a quercetin glycoside or a free amino acid is added to the oral composition, the components may be added in any order. In production of the oral composition, the components are preferably added such that the ratio by weight of the hydroxypropyl cellulose to the protein, the amounts of the protein and the hydroxypropyl cellulose, and the like are in the above respective preferred ranges. Hydroxypropyl cellulose may be added to the protein-containing composition by any method that makes the protein-containing composition ultimately contain the hydroxypropyl cellulose. The method may be selected as appropriate depending on the form of the composition or the like. For example, an oral composition in the form of granules may be produced by a method such as granulating a protein-containing powder raw material, hydroxypropyl cellulose, and optional excipient(s) and the like. An oral composition in the form of tablets may be produced by, for example, compression molding powder containing protein, hydroxypropyl cellulose, and optional excipient(s) and the like, or compression molding the above granules.

The present invention encompasses a method of improving the flavor of a protein-containing oral composition, including adding hydroxypropyl cellulose to a protein-containing oral composition.

Adding hydroxypropyl cellulose to a protein-containing oral composition can reduce the unpleasant flavor of the protein, thereby improving the flavor of the composition. Improvement of the flavor may be improvement of the aftertaste. Hydroxypropyl cellulose is useful in reducing the unpleasant aftertaste of proteins.

The protein and the preferred embodiments thereof are the same as the protein and the preferred embodiments thereof for the oral composition of the present invention. The protein is preferably at least one of milk protein or soy protein, more preferably milk protein, still more preferably whey protein. Hydroxypropyl cellulose and the preferred embodiments thereof are the same as the hydroxypropyl cellulose and the preferred embodiments thereof for the oral composition of the present invention.

In one embodiment of the present invention, adding hydroxypropyl cellulose to a whey protein-containing oral composition can reduce the flavor of whey protein such as the astringent taste, thereby improving the flavor of the composition. Also, in one embodiment, adding hydroxypropyl cellulose to a soy protein-containing oral composition can reduce the flavor of soy protein such as the smell of soybean oil and the bitter taste, thereby improving the flavor of the composition.

The preferred ratio of the amount of the hydroxypropyl cellulose to the amount of the protein is the same as the ratio described for the above protein-containing oral composition of the present invention. The ratio by weight of the hydroxypropyl cellulose to the protein (hydroxypropyl cellulose/protein) is preferably 0.020 or more, more preferably 0.025 or more, still more preferably 0.027 or more, while preferably 0.50 or less, more preferably 0.20 or less, still more preferably 0.16 or less, even more preferably 0.10 or less, particularly preferably 0.065 or less. In the protein-containing oral composition, hydroxypropyl cellulose is preferably used such that the ratio by weight of the hydroxypropyl cellulose to the protein falls within the above ranges. In one embodiment, the hydroxypropyl cellulose can be added to the protein-containing oral composition such that the ratio by weight of the hydroxypropyl cellulose to the protein (hydroxypropyl cellulose/protein) is preferably 0.020 to 0.50, more preferably 0.025 to 0.20, still more preferably 0.027 to 0.16, even more preferably 0.027 to 0.10, particularly preferably 0.027 to 0.065. With the ratio by weight of the hydroxypropyl cellulose to the protein (hydroxypropyl cellulose/protein) in the above ranges, the unpleasant, flavor of the protein can be reduced.

The amount of the protein in the protein-containing oral composition may be, but is not limited to, 4 wt % or more, and is preferably 5 wt % or more, preferably 10 wt % or more, more preferably 30 wt % or more, still more preferably 36 wt % or more, even more preferably 40 wt % or more, particularly preferably 50 wt % or more, most preferably 60 wt. % or more, while preferably 80 wt % or less, more preferably 75 wt % or less. In one embodiment, in order to achieve the effect of the present invention more sufficiently, the protein-containing oral composition contains the protein in an amount of preferably 10 to 80 wt %, preferably 36 to 80 wt %, more preferably 36 to 75 wt %, still more preferably 40 to 75 wt %, even more preferably 50 to 75 wt %, particularly preferably 60 to 75 wt %. In one embodiment, the protein-containing oral composition contains the protein in its solids content in an amount of preferably 10 to 80 wt %, preferably 36 to 80 wt %, more preferably 36 to 75 wt %, still more preferably 40 to 75 wt %, even more preferably 50 to 75 wt %, particularly preferably 60 to 75 wt. %. In one embodiment, the method of improving the flavor of the present invention can be suitably used to improve the flavor of a protein-containing oral composition containing the protein in an amount in the above ranges. In one embodiment, the amount of the protein in a protein-containing oral composition to which hydroxypropyl cellulose is added is preferably in the above ranges.

In the method of improving the flavor of the present invention, hydroxypropyl cellulose is preferably added such that the amount of the hydroxypropyl cellulose in the protein-containing oral composition is preferably 0.1 wt % or more, more preferably 1 wt % or more, still more preferably 2 wt % or more, while preferably 14 wt % or less, more preferably 13 wt % or less, still more preferably 10 wt % or less, particularly preferably 5 wt % or less. In order to reduce the flavor of the protein, the hydroxypropyl cellulose is preferably added in an amount in the above ranges. In one embodiment, the hydroxypropyl cellulose is preferably added such that the amount of the hydroxypropyl cellulose in the protein-containing oral composition is preferably 0.1 to 14 wt %, more preferably 1 to 13 wt %, still more preferably 1 to 10 wt %, even more preferably 1 to 5 wt %, particularly preferably 2 to 5 wt %. In one embodiment, the hydroxypropyl cellulose is added such that the amount of the hydroxypropyl cellulose in a solids content of the protein-containing oral composition is preferably 0.1 to 14 wt %, more preferably 1 to 13 wt %, still more preferably 1 to 10 wt %, even more preferably 1 to 5 wt %, particularly preferably 2 to 5 wt %.

In the method of improving the flavor of the present invention, the protein-containing oral composition may contain at least one of quercetin or a quercetin glycoside. When the protein-containing oral composition contains at least one of quercetin or a quercetin glycoside, the puckery taste of the at least one of quercetin or a quercetin glycoside as well as the unpleasant flavor of the protein can be reduced. The protein-containing oral composition may contain at least one amino acid selected from the group consisting of leucine, isoleucine, and valine, preferably leucine. When the protein-containing oral composition contains the above amino acid(s), the bitter taste of the amino acid(s) as well as the unpleasant flavor of the protein can be reduced. Preferred embodiments of quercetin and quercetin glycoside and the amounts thereof, and the preferred embodiments of the above amino acids and the amounts thereof are the same as those described for the above oral composition. The preferred ranges for the ratio by weight of at least one of quercetin or a quercetin glycoside to the protein, the preferred ranges for the ratio by weight of the amino acid to the protein, and the like are the same as those described above for the oral composition.

The preferred embodiments and the like of the protein-containing composition in the method of improving the flavor of the present invention are the same as those described above for the oral composition of the present, invention. In one embodiment, the protein-containing composition is preferably in a solid form and may be a solid drink mix. In one embodiment, the method of improving the flavor of the present invention is preferably a method Gf improving the flavor of a protein-containing solid drink mix, including adding hydroxypropyl cellulose to a protein-containing solid drink mix.

The method of adding hydroxypropyl cellulose to the protein-containing oral composition may be any method that makes the protein-containing composition ultimately contain the hydroxypropyl cellulose.

Hydroxypropyl cellulose is useful in reducing the unpleasant taste and smell of proteins. The present invention encompasses use of hydroxypropyl cellulose for improving the flavor of a protein-containing oral composition. The protein, the hydroxypropyl cellulose, the preferred embodiments thereof, and the like are the same as those described above for the oral composition of the present invention. Improvement of the flavor may be improvement of the aftertaste of proteins.

### EXAMPLES

Hereinafter, examples that more specifically describe the details of the present invention are shown. The scope of the present invention is not limited to these examples.

The raw materials used in the examples and comparative examples are listed below.

Whey protein powder: Lactocrystal plus (trade name) available from Nippon Shinyaku Co., Ltd., protein content: 91 wt %

Hydroxypropyl cellulose (HPC): CELNY SSL (trade name) available from Nippon Soda Co., Ltd., molecular weight (in weight): 40000

Dextrin: Sandec 150 (trade name) available from Sanwa Starch Co., Ltd.

Quercetin glycoside-containing formulation: San emiq P30 (trade name) available from San-Ei Gen F.F.I., Inc., quercetin glycoside content: 30 wt %

Leucine: L-leucine powder (trade name) available from Protein Chemical Co., Ltd.

Soy protein powder: Proleena 800R (trade name) available from Fuji Oil Co., Ltd., protein content: 90 wt %

### Examples 1 to 6

Protein-containing compositions of Examples 1 to 6 were prepared according to the formulations shown in Table 1 in order to evaluate the effect of reducing the unpleasant flavor of each protein-containing oral composition. Specifically, whey protein powder, HPC, and dextrin in proportions shown in Table 1 were mixed, whereby each protein-containing composition was obtained.

### Comparative Examples 1 to 5

Protein-containing compositions of Comparative Examples 1 to 5 were prepared according to the formulations shown in Table 1 by the same procedure as in Example 1.

### Examples 7 to 12

Protein-containing compositions of Examples 7 to 12 were prepared according to the formulations shown in Table 2 by the same procedure as in Example 1.

### <Preparation of Solution of Protein-Containing Composition>

Each protein-containing composition in an amount of 5.8 g was added to 80 mL of room temperature water in a 200-mL beaker, and completely dissolved in water by manual stirring with a dispensing spoon. The flavor of the solution was sensory evaluated by the following method.

### <Flavor Evaluations>

Two expert panelists sensory evaluated the flavor of the solution (room temperature) of the protein-containing composition in terms of the unpleasant flavor (specifically, the astringent aftertaste) based on the following criteria (on a scale of 1 to 5). The average evaluation points are shown in Tables 1 and 2 (Flavor (evaluation point)). An average evaluation point of 1 to 3.9 is marked as good, 4 to 4.9 as average, and 5 as bad.

Evaluation criteria for flavor
5: A strong astringent taste was sensed.
4: An astringent taste was sensed.
3: A weak astringent taste was sensed.
2: Almost no astringent taste was sensed.
1: No astringent taste was sensed.

The formulations and evaluation results of the protein-containing compositions are shown in Tables 1 and 2. The “Protein content (wt %) in composition” in the tables refers to the amount of the protein in each protein-containing composition. The “HPC/protein” in the tables is the ratio by weight of HPC to the protein in each protein-containing composition.

TABLE 1

| | | | | | | | | Compar- | Compar- | Compar- | Compar- | Compar- |
|---|---|---|---|---|---|---|---|---|---|---|---|---|
| | | | | | | | | ative | ative | ative | ative | ative |
| | | Exam- | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 1 | ple 2 | ple 3 | ple 4 | ple 5 |
| Composition | Whey protein | 5.0 | 10.0 | 12.5 | 15.0 | 40.0 | 70.5 | 10.0 | 12.5 | 15.0 | 40.0 | 70.5 |
| (wt %) | powder | | | | | | | | | | | |
| | HPC | 2.0 | 2.0 | 2.0 | 2.0 | 2.0 | 2.0 | — | — | — | — | — |
| | Dextrin | 93.0 | 88.0 | 85.5 | 83.0 | 58.0 | 27.5 | 90.0 | 87.5 | 85.0 | 60.0 | 29.5 |
| | Total | 100.0 | 100.0 | 100.0 | 100.0 | 100.0 | 100.0 | 100.0 | 100.0 | 100.0 | 100.0 | 100.0 |

| | | | | | | | | | | | |
|---|---|---|---|---|---|---|---|---|---|---|---|
| Protein content (wt %) in | 4.8 | 9.1 | 11.4 | [symbol] | [symbol] | [symbol] | [symbol] | 11.4 | 13.7 | [symbol] | [symbol] |
| composition | | | | | | | | | | | |
| HPC/protein | 0.440 | 0.220 | 0.178 | 0.147 | [symbol] | 0.031 | — | — | — | — | — |
| Flavor (evaluation point) | 2 | 2 | 2 | 2.5 | 2.5 | 3.9 | 3 | 4 | 4 | 4 | [symbol] |
| Flavor | Good | Good | Good | Good | Good | Good | Good | Average | Average | Average | Bad |

[symbol]

indicates data missing or illegible when filed

TABLE 2

| | | Example 7 | Example 8 | Example 9 | Example 10 | Example 11 | Example 12 |
|---|---|---|---|---|---|---|---|
| Composition | Whey protein powder | 70.5 | 70.5 | 70.5 | 70.5 | 70.5 | 70.5 |
| (wt %) | HPC | 4.0 | 10.0 | 12.5 | 15.0 | 20.0 | 25.0 |
| | Dextrin | 25.5 | 19.5 | 17.0 | 14.5 | 9.5 | 4.5 |
| | Total | 100.0 | 100.0 | 100.0 | 100.0 | 100.0 | 100.0 |

| | | | | | | |
|---|---|---|---|---|---|---|
| Protein content (wt %) in composition | 64.2 | 64.2 | 64.2 | 64.2 | 64.2 | 64.2 |
| HPC/protein | 0.062 | 0.156 | 0.195 | 0.234 | 0.312 | 0.389 |
| Flavor (evaluation point) | 3.5 | 3.5 | 3.5 | 4 | 4 | 4 |
| Flavor | Good | Good | Good | Average | Average | Average |

The solution of the protein-containing composition in Comparative Example 5 had a very strong astringent aftertaste of the protein. In the examples in which the solutions of a protein-containing composition contained HPC, the astringent aftertaste of the protein was reduced (suppressed). The flavor of the solution of a protein-containing composition in each of Examples 5 to 12 was also improved. In Examples 10 to 12, the astringent aftertaste of the protein was reduced as compared to that in Comparative Example 5. The astringent aftertaste of the protein was further reduced in Examples 6 to 9.

### Examples 13 to 16

Whey protein powder, HPC, dextrin, and a quercetin glycoside were mixed in proportions shown in Table 3 to prepare protein-containing compositions of Examples 13 to 16.

The amount of the quercetin glycoside in the protein-containing composition of each of Examples 13 to 16 was 0.5 wt %. The ratio by weight of the quercetin glycoside to the protein (quercetin glycoside/protein) in the protein-containing composition was 0.044 in Example 13, 0.037 in Example 14, 0.014 in Example 15, and 0.008 in Example 16.

### Comparative Examples 6 to 9

Protein-containing compositions of Comparative Examples 6 to 9 were prepared according to the formulations shown in Table 3 by the same procedure as in Example 13.

The protein-containing compositions obtained in Examples 13 to 16 and Comparative Examples 6 to 9 each were dissolved in water by the same procedure as in Example 1. The flavor of each solution of a protein-containing composition was evaluated at room temperature by the following method.

### <Flavor Evaluation>

Two expert panelists sensory evaluated the flavor of the solution (room temperature) of the protein-containing composition in terms of the unpleasant flavor (specifically, the astringent aftertaste and the puckery aftertaste) based on the following criteria (on a scale of 1 to 5).

The average evaluation points are shown in Table 3 (Flavor (evaluation point)). An average evaluation point of 1 to 3.9 is marked as good, 4 to 4.9 as average, and 5 as bad.

Evaluation criteria for flavor
5: Strong astringent and puckery tastes were sensed.
4: Astringent and puckery tastes were sensed.
3: Weak astringent and puckery tastes were sensed.
2: Almost no astringent and puckery tastes were sensed.
1: No astringent and puckery tastes were sensed.

TABLE 3

| | | | | | | Compar- | Compar- | Compar- | Compar- |
|---|---|---|---|---|---|---|---|---|---|
| | | | | | | ative | ative | ative | ative |
| | | Exam- | Exam- | Exam- | Exam- | Exam- | Exam- | Exam- | Exam- |
| | | ple 13 | ple 14 | ple 15 | ple 16 | ple 6 | ple 7 | ple 8 | ple 9 |
| Composition | Whey protein powder | 12.5 | 15.0 | 40.0 | 70.5 | 12.5 | 15.0 | 40.0 | 70.5 |
| (wt %) | HPC | 2.0 | 2.0 | 2.0 | 2.0 | — | — | — | — |
| | Dextrin | 83.8 | 81.3 | 56.3 | 25.8 | 85.8 | 83.3 | 58.3 | 27.8 |
| | Quercetin glycoside- | 1.7 | 1.7 | 1.7 | 1.7 | 1.7 | 1.7 | 1.7 | 1.7 |
| | containing formulation | | | | | | | | |
| | Total | 100.0 | 100.0 | 100.0 | 100.0 | 100.0 | 100.0 | 100.0 | 100.0 |

| | | | | | | | | |
|---|---|---|---|---|---|---|---|---|
| Protein content (wt %) in composition | 11.4 | 13.7 | 36.4 | 64.2 | 11.4 | 13.7 | 36.4 | 64.2 |
| HPC/protein | 0.175 | 0.147 | 0.055 | 0.031 | — | — | — | — |
| Flavor (evaluation point) | 2.5 | 3 | 3.5 | 3.5 | 3.5 | 4.5 | 4.5 | 5 |
| Flavor | Good | Good | Good | Good | Good | Average | Average | Bad |

The quercetin glycoside has a unique puckery aftertaste. In Comparative Examples 7 to 9, the solutions had the puckery aftertaste of the quercetin glycoside as well as the astringent aftertaste of the protein. The solution of a protein-containing composition containing HPC in each of Examples 13 to 16 had a reduced astringent aftertaste of the protein and a reduced puckery aftertaste of the quercetin glycoside, thereby having a mild taste as compared to the solutions containing no HPC. The solution of a protein-containing composition in each of Examples 15 and 16 also achieved the same effect.

### Examples 17 to 20

Whey protein powder, HPC, dextrin, and leucine were mixed in proportions shown in Table 4 to prepare protein-containing compositions of Examples 17 to 20.

The ratio by weight of leucine to the protein (leucine/protein) in the protein-containing composition was 0.025 in Example 17, 0.124 in Example IS, 0.012 in Example 19, and 0.062 in Example 20.

### Comparative Examples 10 to 13

Protein-containing compositions of Comparative Examples 10 to 13 were prepared according to the formulations shown in Table 4 by the same procedure as in Example 17.

The protein-containing compositions obtained in Examples 17 to 20 and Comparative Examples 10 to 13 each were dissolved in water by the same procedure as in Example 1. The flavor of each solution of a protein-containing composition was evaluated at room temperature by the following method.

### <Flavor Evaluation>

Two expert panelists sensory evaluated the flavor of the solution (room temperature) of the protein-containing composition in terms of the unpleasant flavor (specifically, the astringent aftertaste and the bitter aftertaste) based on the following criteria (on a scale of 1 to 5).

The average evaluation points are shown in Table 4 (Flavor (evaluation point)). An average evaluation point of 1 to 3.9 is marked as good, 4 to 4.9 as average, and 5 as bad.

Evaluation criteria for flavor
5: Strong astringent and bitter tastes were sensed.
4: Astringent and bitter tastes were sensed.
3: Weak astringent and bitter tastes were sensed.
2: Almost no astringent and bitter tastes were sensed.
1: No astringent and bitter tastes were sensed.

TABLE 4

| | | | | | | Compar- | Compar- | Compar- | Compar- |
|---|---|---|---|---|---|---|---|---|---|
| | | | | | | ative | ative | ative | ative |
| | | Exam- | Exam- | Exam- | Exam- | Exam- | Exam- | Exam- | Exam- |
| | | ple 17 | ple 18 | ple 19 | ple 20 | ple 10 | ple 11 | ple 12 | ple 13 |
| Composition | Whey protein powder | 40.0 | 40.0 | 80.0 | 80.0 | 40.0 | 40.0 | 80.0 | 80.0 |
| (wt %) | HPC | 2.0 | 2.0 | 2.0 | 2.0 | — | — | — | — |
| | Dextrin | 57.1 | 53.5 | 17.1 | 13.5 | 59.1 | 55.5 | 1 [symbol] .1 | 15.5 |
| | Leucine | 0.9 | 4.5 | 0.9 | 4.5 | 0.9 | 4.5 | 0.9 | 4.5 |
| | Total | 100.0 | 100.0 | 100.0 | 100.0 | 100.0 | 100.0 | 100.0 | 100.0 |

| | | | | | | | | |
|---|---|---|---|---|---|---|---|---|
| Protein content (wt %) in composition | 36.4 | 36.4 | 72.8 | 72.8 | 36.4 | 36.4 | 72.8 | 72.8 |
| HPC/protein | 0.055 | 0.059 | 0.027 | 0.027 | — | — | — | — |
| Flavor (evaluation point) | 3 | 3.5 | 3.5 | 4 | 4 | 4.5 | 5 | 5 |
| Flavor | Good | Good | Good | Average | Average | Average | Bad | Bad |

[symbol]

indicates data missing or illegible when filed

Leucine has a unique bitter aftertaste. The solution of a protein-containing composition in each of Comparative Examples 10 to 13 had a sharp bitter aftertaste of leucine as well as the astringent aftertaste of the protein.

The solution of a protein-containing composition containing HPC in each of Examples 17 to 20 had a reduced astringent aftertaste of the protein and a reduced bitter taste of leucine.

### Examples 21 and 22

The protein used was soy protein which is a type of protein different from whey protein. Soy protein powder, HPC, dextrin, and a quercetin glycoside were mixed in proportions shown in Table 5 to prepare protein-containing compositions of Examples 21 and 22. The amount of the quercetin glycoside in the protein-containing composition of Example 22 was 0.5 wt %. The ratio by weight of the quercetin glycoside to the protein (quercetin glycoside/protein) in the protein-containing composition was 0.008 in Example 22.

### Comparative Examples 14 and 15

Protein-containing compositions of Comparative Examples 14 and 15 were prepared according to the formulations shown in Table 5 by the same procedure as in Example 21.

The protein-containing composition obtained in Examples 21 and 22 and Comparative Examples 14 and 15 each were dissolved in water by the same procedure as in Example 1. The flavor of each solution was evaluated at room temperature by the following method.

### <Flavor Evaluation>

Two expert panelists sensory evaluated the flavor of the solution (room temperature) of the protein-containing composition in terms of the unpleasant flavor (specifically, the smell of soybean oil left in the mouth and the bitter aftertaste) based on the following criteria (on a scale of 1 to 5). An average evaluation point of 1 to 3.9 is marked as good, 4 to 4.9 as average, and 5 as poor.

Evaluation criteria for flavor
5: A strong smell of soybean oil and a strong bitter taste were sensed.
4: A smell of soybean oil and a bitter taste were sensed.
3: A weak smell of soybean oil and a bitter taste were sensed.
2: Almost no smell of soybean oil and almost no bitter taste were sensed.
1: No smell of soybean oil and no bitter taste were sensed.

In comparison of Example 21 and Comparative Example 14, the solution of Example 21 had a clean aftertaste with a reduced oily, thick mouthfeel and a reduced bitter taste. In comparison of Example 22 and Comparative Example 15 in each of which a quercetin glycoside was added, the solution of Example 22 achieved the same effect and thereby had clean, light aftertaste.

TABLE 5

| | | | | Comparative | Comparative |
|---|---|---|---|---|---|
| | | Example 21 | Example 22 | Example 14 | Example 15 |
| Composition | Soy protein powder | 70.5 | 70.5 | 70.5 | 70.5 |
| (wt %) | HPC | 2.0 | 2.0 | — | — |
| | Dextrin | 27.5 | 25.8 | 29.5 | 27.8 |
| | Quercetin glycoside- | — | 1.7 | — | 1.7 |
| | containing formulation | | | | |
| | Total | 100.0 | 100.0 | 100.0 | 100.0 |

| | | | | |
|---|---|---|---|---|
| Protein content (wt %) in composition | 63.5 | 63.5 | 63.5 | 63.5 |
| HPC/protein | 0.031 | 0.031 | — | — |
| Flavor (evaluation point) | 3.5 | 3.5 | 5 | 5 |
| Flavor | Good | Good | Bad | Bad |

The above results show that adding HPC successfully achieved effective reduction of the unpleasant aftertaste of proteins. The results show that the unpleasant flavor of proteins is reduced by adding HPC.

### INDUSTRIAL APPLICABILITY

The present invention is useful in the fields of food, beverages, and the like.

1. A protein-containing oral composition comprising a protein and hydroxypropyl cellulose at a ratio by weight of the hydroxypropyl cellulose to the protein (hydroxypropyl cellulose/protein) of 0.020 to 0.50.

2. The protein-containing oral composition according to claim 1,
wherein the ratio by weight of the hydroxypropyl cellulose to the protein (hydroxypropyl cellulose/protein) is 0.025 to 0.20.

3. The protein-containing oral composition according to claim 1,
wherein the protein is at least one of milk protein or soy protein.

4. The protein-containing oral composition according to claim 1, further comprising at least one of quercetin or a quercetin glycoside.

5. The protein-containing oral composition according to claim 1, further comprising at least one amino acid selected from the group consisting of leucine, isoleucine, and valine.

6. A method of improving a flavor of a protein-containing oral composition, comprising
adding hydroxypropyl cellulose to a protein-containing oral composition.

7. The method of improving a flavor according to claim 6,
wherein the hydroxypropyl cellulose is added such that a ratio by weight of the hydroxypropyl cellulose to the protein (hydroxypropyl cellulose/protein) is 0.020 to 0.50.

8. The method of improving a flavor according to claim 6,
wherein the hydroxypropyl cellulose is added such that a ratio by weight of the hydroxypropyl cellulose to the protein (hydroxypropyl cellulose protein) is 0.025 to 0.20.

9. The method of improving a flavor according to claim 6,
wherein the protein is at least one of milk protein or soy protein.

10. The method of improving a flavor according to claim 6,
wherein the protein-containing oral composition further comprises at least one of quercetin or a quercetin glycoside.

11. The method of improving a flavor according to claim 6,
wherein the protein-containing oral composition further comprises at least one amino acid selected from the group consisting of leucine, isoleucine, and valine.

12. Use of hydroxypropyl cellulose for improving a flavor of a protein-containing oral composition.
